(19) United States
(12) Patent Application Publication
(10) Pub. No.: US 2026/0180889 A1
(43) Pub. Date: Jun. 25, 2026

(54) TRANSMISSION CONTROL PROTOCOL TRAFFIC SIMULATION

(71) Applicant: Rakuten Symphony, Inc., Tokyo (JP)

(72) Inventors: Mrinal NANDI, Bangalore (IN); Argha MUKHERJEE, Bangalore (IN); Varun Kumar PENDYALA, Bangalore (IN)

(73) Assignee: Rakuten Symphony, Inc., Tokyo (JP)

(21) Appl. No.: 18/987,757

(22) Filed: Dec. 19, 2024

(51) Int. Cl. H04L 43/55; H04L 12/46

(52) U.S. Cl. CPC H04L 43/55; H04L 12/4633

(57) ABSTRACT

A method, apparatus, and system for cloud native data streaming for Transmission Control Protocol (TCP) traffic simulation may be provided and may include, receiving, by a tunneling interface of a distributed unit (DU) of a telecommunications network, a packet originating from a traffic generator of the DU; generating, by the tunneling interface, a destination-based route towards an application server of the telecommunications network based on receiving the packet from the traffic generator; and forwarding, by the tunneling interface, the packet including the destination-based route to a simulation application in the DU, wherein the simulation application is configured to send the packet towards the application server based on the destination-based route upon receiving the packet.

### FIELD

The present disclosure relates to transmission control protocol (TCP) traffic simulation.

### BACKGROUND

The information disclosed in this background section is only for enhancement of understanding of the general background of the disclosure and should not be taken as an acknowledgement or any form of suggestion that this information forms the prior art already known to a person skilled in the art.

In the related art, traffic simulation may be performed on telecommunications network in order to perform tests and the like. To this end, both User Datagram Protocol (UDP) and Transmission Control Protocol (TCP) traffic may be simulated when testing. UDP traffic generation may generally be more simple to simulate since it only requires source port, destination port, length, and checksum.

### SUMMARY

However, TCP traffic generation for the purposes of simulation is more complex, and systems in the related art may require the entire TCP stack to be implemented. This may require more time for production to be prepared, and for networks such as LTE and 5G, multiple bearers may be simulated, greatly increasing the processing power required in order to test such systems.

Accordingly, there is a need for a more efficient method for generating and simulating TCP traffic.

According to embodiments, a method, apparatus, and system for Transmission Control Protocol (TCP) traffic simulation may be provided and may include, receiving, by a tunneling interface of a distributed unit (DU) of a telecommunications network, a packet originating from a traffic generator of the DU; generating, by the tunneling interface, a destination-based route towards an application server of the telecommunications network based on receiving the packet from the traffic generator; and forwarding, by the tunneling interface, the packet including the destination-based route to a simulation application in the DU, wherein the simulation application is configured to send the packet towards the application server based on the destination-based route upon receiving the packet.

Based on the above embodiments, it can be understood that the above embodiments are achieved without needing to implement the full TCP stack, since the tunneling interface can achieve the function of allowing the destination based route to be added (without needing to actually implement a full TCP stack), such that a more efficient method for generating TCP traffic is achieved.

According to embodiments, a tunneling interface of a distributed unit (DU) of a telecommunications network may be provided The tunneling interface may be configured to: receive, by a tunneling interface of a distributed unit (DU) of a telecommunications network, a packet originating from a traffic generator of the DU; generate, by the tunneling interface, a destination-based route towards an application server of the telecommunications network based on receiving the packet from the traffic generator; and forward, by the tunneling interface, the packet including the destination-based route to a simulation application in the DU, wherein the simulation application is configured to send the packet towards the application server based on the destination-based route upon receiving the packet.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a system architecture diagram for generating simulated traffic according to an embodiment;

FIG. 2 illustrates a flowchart diagram for traffic simulation in uplink according to an embodiment;

FIG. 3 illustrates a flowchart diagram for traffic simulation in downlink according to an embodiment;

FIG. 4 illustrates an example packet data format according to an embodiment;

FIG. 5 illustrates a flowchart diagram for a method for using a tunneling interface in generating simulated traffic in uplink according to an embodiment;

FIG. 6 illustrates a flowchart diagram for a method for using a simulation application in receiving simulated traffic in downlink according to an embodiment;

FIG. 7 is a diagram of an example environment in which systems and/or methods, described herein, may be implemented; and

FIG. 8 is a diagram of example components of a device according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, a method, apparatus, and system for Transmission Control Protocol (TCP) traffic simulation may be provided and may include, receiving, by a tunneling interface of a distributed unit (DU) of a telecommunications network, a packet originating from a traffic generator of the DU; generating, by the tunneling interface, a destination-based route towards an application server of the telecommunications network based on receiving the packet from the traffic generator; and forwarding, by the tunneling interface, the packet including the destination-based route to a simulation application in the DU, wherein the simulation application is configured to send the packet towards the application server based on the destination-based route upon receiving the packet.

Based on the above embodiments, it can be understood that the above embodiments are achieved without needing to implement the full TCP stack, since the tunneling interface can achieve the function of allowing the destination based route to be added (without needing to actually implement a full TCP stack), such that a more efficient method for generating TCP traffic is achieved. Accordingly, the above method can be used for multi bearers use cases (such as in LTE and 5G), (for example, at least ten thousand TCP bearers could be simulating by using the tunneling interface).

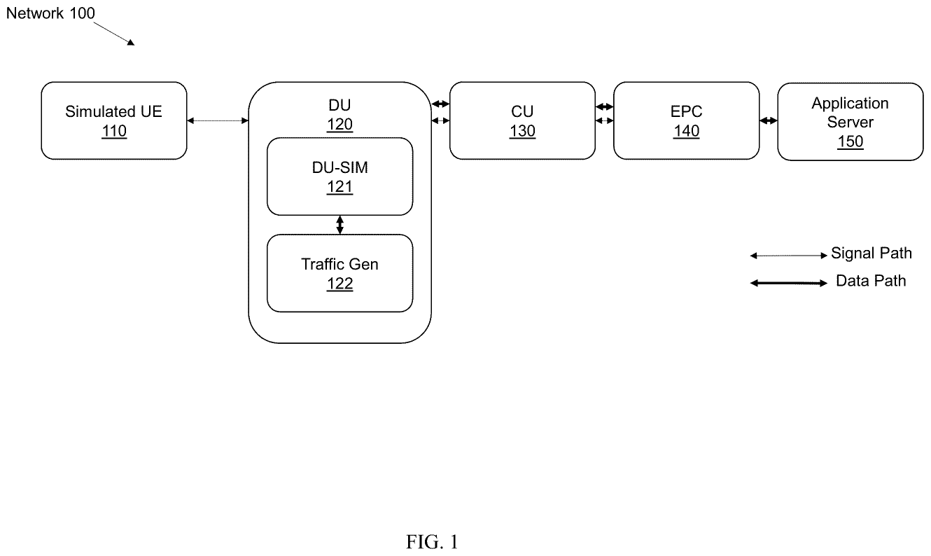

FIG. 1 illustrates a system architecture diagram for generating simulated traffic according to an embodiment. Network 100 (which may also be referred to as a “telecommunications network” interchangeably herein) is provided and may include simulated user equipment (UE) 110, distributed unit (DU) 120, centralized unit (CU) 130, evolved packet core (EPC) 140, and application server 150.

Application server 150 is the furthest upstream of the traffic generation, whereas the simulated UE 110 is the furthest downstream. DU 120, CU 130, and EPC 140 comprise the midhaul.

DU 120 may also include a DU simulation application (DU-SIM) 121 and traffic generator 122.

The signaling path for facilitating communication may be between the simulated UE 110, DU 120 (DU-SIM 121 in combination with traffic generator 122), CU 130, EPC 140, and application server 150. The data path for testing the traffic generation may be between the application server 150 to the traffic generator 122 via the EPC 140, CU 130, and DU-SIM 121.

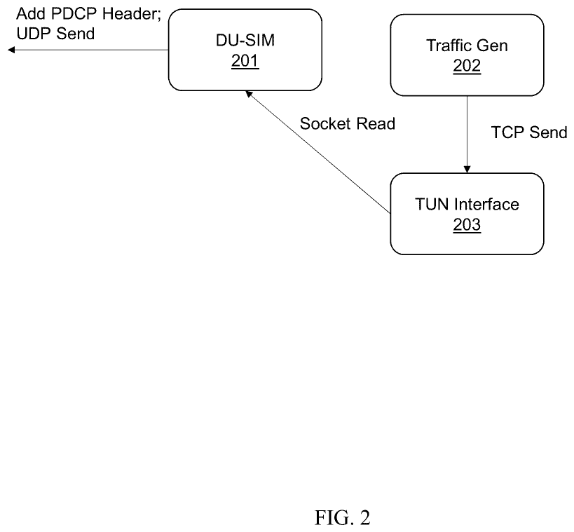

FIG. 2 illustrates a flowchart diagram for traffic simulation in uplink according to an embodiment. DU-SIM 201, traffic generator 202, and tunneling (TUN) interface 203 are provided and comprised in the DU (e.g., DU 120 above). Upstream of the DU-SIM is the application server, EPC, and CU (as illustrated in FIG. 1 above).

According to a first step, the traffic generator 202 may send a packet (such as by using TCP socket send) to send the packet to TUN interface 203.

According to a second step, a kernel in the DU may generate a TCP header such that the processing required for performing this task may be offloaded to the kernel. This is so that this task does not necessarily need to be performed by DU-SIM 201 or traffic generator 202.

According to a third step, once the packet sent in the first step reaches TUN interface 203, a destination-based route towards the application server may be added. This may include specifying the IP of the application server, and assigning an IP subnet of the simulated UE which is associated with TUN interface 203 to the packet.

According to a fourth step, DU-SIM 201 may read from TUN interface 203 and add other required protocol headers (aside from the TCP header in the second step), this may particularly be a protocol header such as Packet Data Convergence Protocol (PDCP).

According to a fifth step, DU-SIM 201 may send the packets towards the application server (e.g., using UDP send).

Based on the above, it can be understood that TUN interface 203 may add a destination-based route associated with the IP subnet of a simulated UE, thereby alleviating the requirement to fully implement the TCP stack.

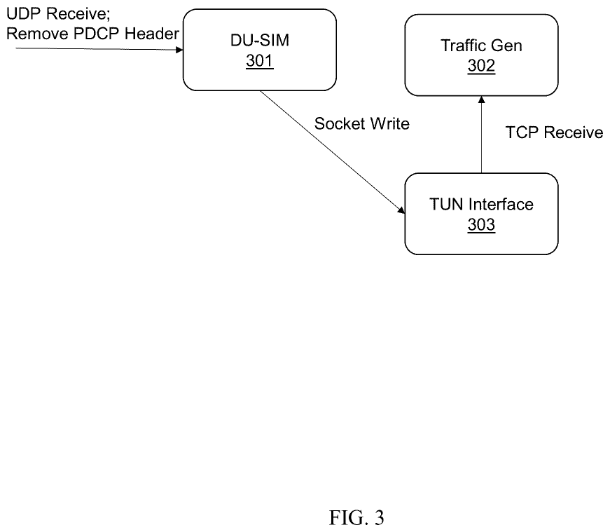

FIG. 3 illustrates a flowchart diagram for traffic simulation in downlink according to an embodiment. DU-SIM 301, traffic generator 302, and tunneling (TUN) interface 303 are provided and comprised in the DU. Upstream of DU-SIM 301 is the application server, EPC, and CU (as illustrated in FIG. 1 above).

According to a first step, the packet which is sent from the application server may be received by DU-SIM 301 (e.g., via UDP receive).

According to a second step, DU-SIM 301 may process the packet and remove any unnecessary headers (e.g., PDCP).

According to a third step, DU-SIM 301 may perform a socket write operation in order to send/forward the data packet to TUN interface 303.

According to a fourth step, the kernel (integrated into the DU) may remove the TCP header and send the data packet to traffic generator 302. Accordingly, any TCP header validation and retransmission is offloaded to the kernel, thereby alleviating the requirement of such tasks being performed by DU-SIM 301 or traffic generator 302.

According to a fifth step, traffic generator 302 receives the packet. Accordingly, tasks such as diagnostics or testing may be performed based on analyzing the packet received at the traffic generator in order to determine whether the network is performing properly, etc.

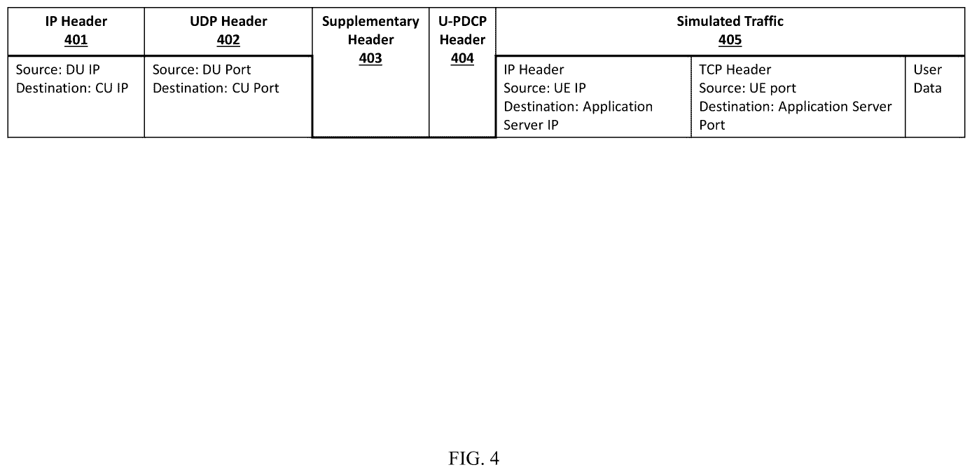

FIG. 4 illustrates an example packet data format according to an embodiment. IP header 401, UDP header 402, supplementary header 403, U-PDCP header 404, and simulated traffic portion 405 may be provided.

IP header 401 may include the source IP (DU) and destination IP (CU). UDP header 402 may specify the ports for the source (DU) and the destination (CU). A supplementary header 403 (e.g., header which may provide any additional or supplementary information for usage during the simulation) may be included.

A sub-unit (simulated traffic portion 405) for handling the TCP portion of the simulated traffic may be provided and may include an IP header (UE as the source IP, application server as the destination IP), TCP header (specifying the user application port as the source and the application server port as the destination) along with the simulated user data is also included. It should be appreciated that the above is merely an example structure for the data packet, and other structures may be implemented depending on the specific implementation.

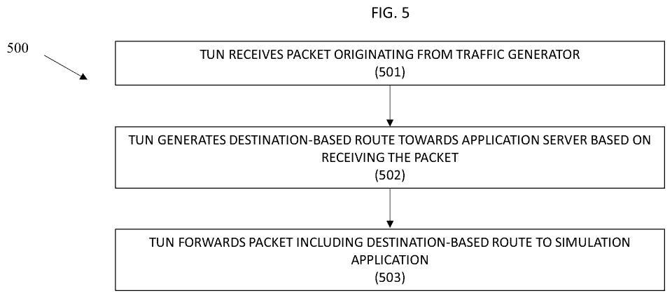

FIG. 5 illustrates a flowchart diagram for a method 500 of using a tunneling interface for generating simulated traffic in uplink according to an embodiment.

According to operation 501, tunneling (TUN) interface may receive a packet originating from a traffic generator. The packet may be a TCP packet.

According to operation 502, TUN interface may generate a destination-based route towards the application server based on receiving the packet. A kernel in the DU may be configured to generate a TCP header to add to the packet. The TCP header may also include a simulated UE of the telecommunications as the source port, and the application server as the destination port. The destination-based route may specifically include the IP subnet of the simulated UE as a source IP, and the IP of the application server as a destination IP, and said destination-based route may be included in the packet (e.g., in one of the headers).

According to operation 503, TUN interface may forward the packet including the destination-based route to the simulation application. The simulation application may be configured to send the packet towards the application server based on the destination-based route upon receiving the packet (for example, using UDP send). According to embodiments, the simulation application may firstly be configured to add a PDCP header to the packet.

According to embodiments, the packet may further include an IP header specifying the IP of the DU as a source IP and the CU as a destination IP, a UDP header specifying the DU as a source port and the CU as a destination port, and a supplementary header, wherein the data path of the packet from the DU-SIM to the application server also includes the midhaul CU and EPC.

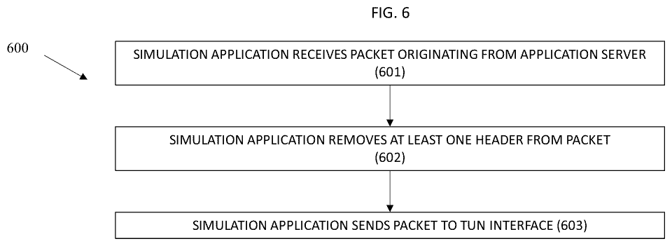

FIG. 6 illustrates a flowchart diagram for a method 600 of using a simulation application for receiving simulated traffic in downlink according to an embodiment.

According to operation 601, the simulation application may receive a packet originating from the application server. The packet may be a TCP packet. This may be received via a method such as UDP receive.

According to operation 602, the simulation application may process the packet to remove at least one header from the packet (e.g., PDCP).

According to operation 603, the simulation application may send the packet to the TUN interface. The kernel may be configured to perform TCP header validation and subsequently remove the TCP header from the packet. The TCP header may have included the application server as the source port, and a simulated UE of the telecommunications network as the destination port. The TUN interface may be configured to forward the packet to the traffic generator of the DU upon receiving the packet.

Based on the above embodiments, it can be understood that the above embodiments are achieved without needing to implement the full TCP stack, since the tunneling interface can achieve the function of allowing the destination based route to be added (without needing to actually implement a full TCP stack), such that a more efficient method for generating TCP traffic is achieved. Accordingly, the above method can be used for multi bearers use cases (such as in LTE and 5G), (for example, at least ten thousand TCP bearers could be simulating by using the tunneling interface).

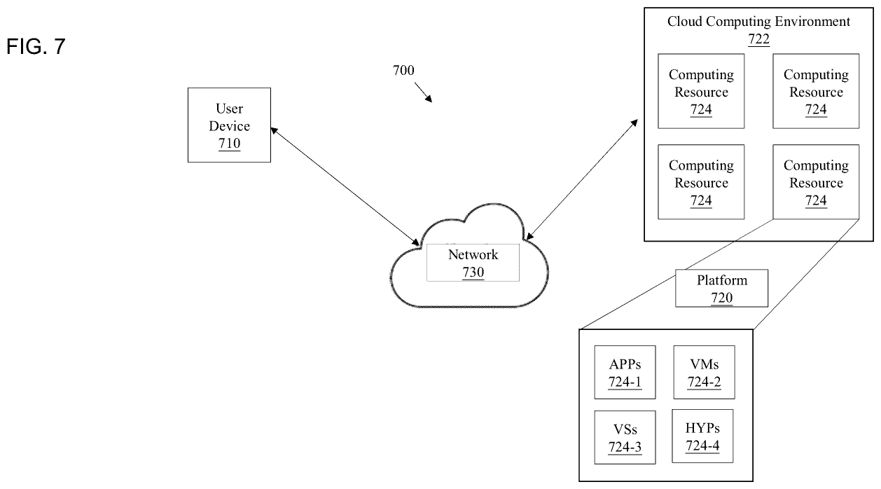

FIG. 7 is a diagram of an example environment 700 in which systems and/or methods, described herein, may be implemented. As shown in FIG. 7, environment 700 may include a user device 710, a platform 720, and a network 730. Devices of environment 700 may interconnect via wired connections, wireless connections, or a combination of wired and wireless connections. In embodiments, any of the functions and operations described with reference to FIGS. 1-6 above may be performed by any combination of elements illustrated in FIG. 7.

User device 710 includes one or more devices capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 710 may receive information from and/or transmit information to platform 720.

Platform 720 includes one or more devices capable of receiving, generating, storing, processing, and/or providing information. In some implementations, platform 720 may include a cloud server or a group of cloud servers. In some implementations, platform 720 may be designed to be modular such that certain software components may be swapped in or out depending on a particular need. As such, platform 720 may be easily and/or quickly reconfigured for different uses.

In some implementations, as shown, platform 720 may be hosted in cloud computing environment 722. Notably, while implementations described herein describe platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts platform 720. Cloud computing environment 722 may provide computation, software, data access, storage, etc., services that do not require end-user (e.g., user device 710) knowledge of a physical location and configuration of system(s) and/or device(s) that hosts platform 720. As shown, cloud computing environment 722 may include a group of computing resources 724 (referred to collectively as “computing resources 724” and individually as “computing resource 724”).

Computing resource 724 includes one or more personal computers, a cluster of computing devices, workstation computers, server devices, or other types of computation and/or communication devices. In some implementations, computing resource 724 may host platform 720. The cloud resources may include compute instances executing in computing resource 724, storage devices provided in computing resource 724, data transfer devices provided by computing resource 724, etc. In some implementations, computing resource 724 may communicate with other computing resources 724 via wired connections, wireless connections, or a combination of wired and wireless connections.

As further shown in FIG. 7, computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

Application 724-1 includes one or more software applications that may be provided to or accessed by user device 710. Application 724-1 may eliminate the need to install and execute the software applications on user device 710. For example, application 724-1 may include software associated with platform 720 and/or any other software capable of being provided via cloud computing environment 722. In some implementations, one application 724-1 may send/receive information to/from one or more other applications 724-1, via virtual machine 724-2.

Virtual machine 724-2 includes a software implementation of a machine (e.g., a computer) that executes programs like a physical machine. Virtual machine 724-2 may be either a system virtual machine or a process virtual machine, depending upon use and degree of correspondence to any real machine by virtual machine 724-2. A system virtual machine may provide a complete system platform that supports execution of a complete operating system (“OS”). A process virtual machine may execute a single program, and may support a single process. In some implementations, virtual machine 724-2 may execute on behalf of a user (e.g., user device 710), and may manage infrastructure of cloud computing environment 722, such as data management, synchronization, or long-duration data transfers.

Virtualized storage 724-3 includes one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. Hypervisor 724-4 may present a virtual operating platform to the guest operating systems and may manage the execution of the guest operating systems. Multiple instances of a variety of operating systems may share virtualized hardware resources.

Network 730 includes one or more wired and/or wireless networks. For example, network 730 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

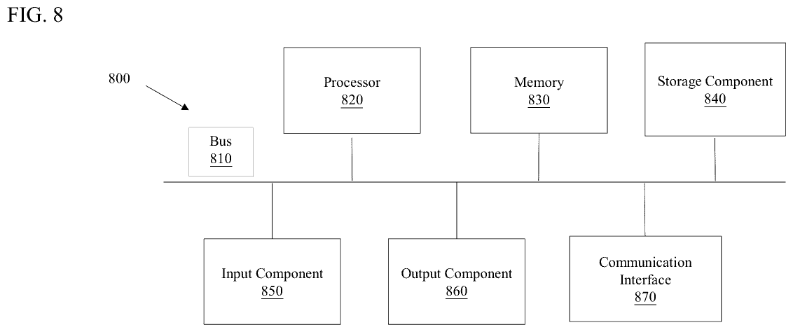

FIG. 8 illustrates an embodiment of a device 800. As shown in FIG. 8, the device 800 processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single core processor, or a combination of one or more multi-core processors and/or one or more single core processors, a distributed processing system, or the like. The processor 810 may be a Central Processing Unit (CPU)a graphics processing unit (GPU), an accelerated processing unit (APU), an application-specific integrated circuit (ASIC), or another type of processing component.

Memory 820 includes a non-transitory computer readable medium. Memory 820 includes a random-access memory (RAM), a read only memory (ROM), and/or another type of dynamic or static storage device (e.g., a flash memory, a magnetic memory, and/or an optical memory) that stores information and/or instructions for use by processor 810. The memory 820 comprises machine-readable instructions which are executable by the processor 810. These machine-readable instructions when executed by the processor 810 cause the processor 810 to perform one or more method steps of an embodiment described above.

Storage component 830 stores information and/or software related to the operation and use of the device 800. For example, storage component 830 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a global positioning system (GPS), an accelerometer, a gyroscope, and/or an actuator).

Output component 850 is configured to provide output information from the device 800. For example, the output component 850 may be, but not limited to, a display, a speaker, instructions to an external device, and/or one or more light-emitting diodes (LEDs).

Communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800. Further, one or more method steps described in any of the embodiments may be performed utilizing a plurality of devices 800 in communication with one another.

In embodiments, any one of the operations or processes of FIGS. 1-6 may be implemented by or using any one of the elements illustrated in FIGS. 7 and 8. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1] A method including: receiving, by a tunneling interface of a distributed unit (DU) of a telecommunications network, a packet originating from a traffic generator of the DU; generating, by the tunneling interface, a destination-based route towards an application server of the telecommunications network based on receiving the packet from the traffic generator; and
forwarding, by the tunneling interface, the packet including the destination-based route to a simulation application in the DU, wherein the simulation application is configured to send the packet towards the application server based on the destination-based route upon receiving the packet.
Item [2] The method according to Item [1], wherein the packet includes a Transmission Control Protocol (TCP) packet, and wherein a kernel in the DU is configured to generate a TCP header to add to the packet.
Item [3] The method according to Item [2], wherein the TCP header includes a simulated user equipment (UE) of the telecommunications as the source port, and the application server as the destination port.
Item [4] The method according to Item [3], wherein the simulation application is configured to add a Packet Data Convergence Protocol (PDCP) header to the packet.
Item [5] The method according to Item [4], wherein the destination-based route includes an Internet Protocol (IP) subnet of the simulated UE as a source IP address, and an IP of the application server as a destination IP address.
Item [6] The method according to any one of Items [1]-[5], wherein the simulation application is configured to send the packet to the application server using User Datagram Protocol (UDP) send.
Item [7] The method according to Item [6], wherein a data path of the packet includes a centralized unit (CU) of the telecommunications network and an evolved packet core (EPC) of the telecommunications network, herein the packet includes: an IP header specifying an IP of the DU as a source IP address and the CU as a destination IP address; a UDP header specifying the DU as a source port and the CU as a destination port; and a supplementary header.
Item [8]. The method according to any one of items [1]-[6], further including: receiving, by the tunneling interface, a downlink packet from the application server via the simulation application; and forwarding, by the tunneling interface, the downlink packet to the traffic generator.
Item [9] The method according to Item [8], wherein the downlink packet includes a TCP packet, wherein the simulation application is configured to process the downlink packet by removing at least one header from the downlink packet, and wherein a kernel of the DU is performed to perform TCP header validation and subsequently remove a TCP header from the packet.
Item [10] The method according to Item [9], wherein the TCP header includes the application server as the source port, and a simulated UE of the telecommunications network as the destination port.
Item [11] A tunneling interface of a distributed unit (DU) of a telecommunications network; wherein the tunneling interface is configured to: receive, by a tunneling interface of a distributed unit (DU) of a telecommunications network, a packet originating from a traffic generator of the DU; generate, by the tunneling interface, a destination-based route towards an application server of the telecommunications network based on receiving the packet from the traffic generator; and forward, by the tunneling interface, the packet including the destination-based route to a simulation application in the DU, wherein the simulation application is configured to send the packet towards the application server based on the destination-based route upon receiving the packet.
Item [12] The tunneling interface according to Item [11], wherein the packet includes a Transmission Control Protocol (TCP) packet, and wherein a kernel in the DU is configured to generate a TCP header to add to the packet.
Item [13] The tunneling interface according to Item [12], wherein the TCP header includes a simulated user equipment (UE) of the telecommunications as the source port, and the application server as the destination port.
Item [14] The tunneling interface according to Item [13], wherein the simulation application is configured to add a Packet Data Convergence Protocol (PDCP) header to the packet.
Item [15] The tunneling interface according to Item [14], wherein the destination-based route includes an Internet Protocol (IP) subnet of the simulated UE as a source IP address, and an IP of the application server as a destination IP address.
Item [16] The tunneling interface according to any one of Items [11]-[15], wherein the simulation application is configured to send the packet to the application server using User Datagram Protocol (UDP) send.
Item [17] The tunneling interface according to Item [16], wherein a data path of the packet includes a centralized unit (CU) of the telecommunications network and an evolved packet core (EPC) of the telecommunications network, wherein the packet includes: an IP header specifying an IP of the DU as a source IP address and the CU as a an IP header specifying an IP of the DU as a source IP address and the CU as a as a destination port; and a supplementary header.
Item [18] The tunneling interface according to any one if Items [11]-[17], further configured to: receive a downlink packet from the application server via the simulation application; and forward the downlink packet to the traffic generator.
Item [19] The tunneling interface according to Item [18], wherein the downlink packet includes a TCP packet, wherein the simulation application is configured to process the downlink packet by removing at least one header from the downlink packet, and wherein a kernel of the DU is performed to perform TCP header validation and subsequently remove a TCP header from the packet.
Item [20] The tunneling interface according to Item [19], wherein the TCP header includes the application server as the source port, and a simulated UE of the telecommunications network as the destination port.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by a tunneling interface of a distributed unit (DU) of a telecommunications network, a packet originating from a traffic generator of the DU;
generating, by the tunneling interface, a destination-based route towards an application server of the telecommunications network based on receiving the packet from the traffic generator; and
forwarding, by the tunneling interface, the packet including the destination-based route to a simulation application in the DU, wherein the simulation application is configured to send the packet towards the application server based on the destination-based route upon receiving the packet.

2. The method as claimed in claim 1, wherein the packet comprises a Transmission Control Protocol (TCP) packet, and wherein a kernel in the DU is configured to generate a TCP header to add to the packet.

3. The method as claimed in claim 2, wherein the TCP header comprises a simulated user equipment (UE) of the telecommunications as the source port, and the application server as the destination port.

4. The method as claimed in claim 3, wherein the simulation application is configured to add a Packet Data Convergence Protocol (PDCP) header to the packet.

5. The method as claimed in claim 4, wherein the destination-based route comprises an Internet Protocol (IP) subnet of the simulated UE as a source IP address, and an IP of the application server as a destination IP address.

6. The method as claimed in claim 1, wherein the simulation application is configured to send the packet to the application server using User Datagram Protocol (UDP) send.

7. The method as claimed in claim 6, wherein a data path of the packet includes a centralized unit (CU) of the telecommunications network and an evolved packet core (EPC) of the telecommunications network,
wherein the packet comprises:
an IP header specifying an IP of the DU as a source IP address and the CU as a destination IP address;
a UDP header specifying the DU as a source port and the CU as a destination port; and
a supplementary header.

8. The method as claimed in claim 1, further comprising:
receiving, by the tunneling interface, a downlink packet from the application server via the simulation application; and
forwarding, by the tunneling interface, the downlink packet to the traffic generator.

9. The method as claimed in claim 8, wherein the downlink packet comprises a TCP packet, wherein the simulation application is configured to process the downlink packet by removing at least one header from the downlink packet, and wherein a kernel of the DU is performed to perform TCP header validation and subsequently remove a TCP header from the packet.

10. The method as claimed in claim 9, wherein the TCP header comprises the application server as the source port, and a simulated UE of the telecommunications network as the destination port.

11. A tunneling interface of a distributed unit (DU) of a telecommunications network; wherein the tunneling interface is configured to:
receive, by a tunneling interface of a distributed unit (DU) of a telecommunications network, a packet originating from a traffic generator of the DU;
generate, by the tunneling interface, a destination-based route towards an application server of the telecommunications network based on receiving the packet from the traffic generator; and
forward, by the tunneling interface, the packet including the destination-based route to a simulation application in the DU, wherein the simulation application is configured to send the packet towards the application server based on the destination-based route upon receiving the packet.

12. The tunneling interface as claimed in claim 11, wherein the packet comprises a Transmission Control Protocol (TCP) packet, and wherein a kernel in the DU is configured to generate a TCP header to add to the packet.

13. The tunneling interface as claimed in claim 12, wherein the TCP header comprises a simulated user equipment (UE) of the telecommunications as the source port, and the application server as the destination port.

14. The tunneling interface as claimed in claim 13, wherein the simulation application is configured to add a Packet Data Convergence Protocol (PDCP) header to the packet.

15. The tunneling interface as claimed in claim 14, wherein the destination-based route comprises an Internet Protocol (IP) subnet of the simulated UE as a source IP address, and an IP of the application server as a destination IP address.

16. The tunneling interface as claimed in claim 11, wherein the simulation application is configured to send the packet to the application server using User Datagram Protocol (UDP) send.

17. The tunneling interface as claimed in claim 16, wherein a data path of the packet includes a centralized unit (CU) of the telecommunications network and an evolved packet core (EPC) of the telecommunications network,
wherein the packet comprises:
an IP header specifying an IP of the DU as a source IP address and the CU as a as a destination port; and
a supplementary header.

18. The tunneling interface as claimed in claim 11, further configured to:
receive a downlink packet from the application server via the simulation application; and
forward the downlink packet to the traffic generator.

19. The tunneling interface as claimed in claim 18, wherein the downlink packet comprises a TCP packet, wherein the simulation application is configured to process the downlink packet by removing at least one header from the downlink packet, and wherein a kernel of the DU is performed to perform TCP header validation and subsequently remove a TCP header from the packet.

20. The tunneling interface as claimed in claim 19, wherein the TCP header comprises the application server as the source port, and a simulated UE of the telecommunications network as the destination port.
